(19) United States
(12) Patent Application Publication
(10) Pub. No.: US 2023/0159307 A1
(43) Pub. Date: May 25, 2023

(54) LUMBER GRABBER FOR AUTOMATED CRANE

(71) Applicant: Idaho Forest Group, LLC, Coeur d'Alene, ID (US)

(72) Inventors: Marc BRINKMEYER, Coeur d'Alene, ID (US); Chad KOSMICKI, Coeur d'Alene, ID (US); Alex GOMEZ, Coeur d'Alene, ID (US); Clifton Neil BREWER, Rathdrum, ID (US)

(73) Assignee: Idaho Forest Group, LLC, Coeur d'Alene, ID (US)

(21) Appl. No.: 17/989,651

(22) Filed: Nov. 17, 2022

Related U.S. Application Data
(60) Provisional application No. 63/281,477, filed on Nov. 19, 2021.

(51) Int. Cl. B66C 3/16; B66C 17/26; B66C 13/48; B66C 13/46; B66C 1/32

(52) U.S. Cl. CPC B66C 3/16; B66C 17/26; B66C 13/48; B66C 13/46; B66C 1/32

(57) ABSTRACT

The technology disclosed relates a lumber grabber for grasping timber. The lumber grabber can achieve grasping large packages of lumber of various work lengths. In one configuration, the lumber grabber includes moveable forks for grasping lumber movably supported by a frame, affixable to a crane. Forks positioned at ends of the frame and arranged to open and close relative to one other under power by a source of motive force; thereby enabling grasping and ungrasping of packages of lumber under programmed control of a programmable controller executing stored instructions.

### PRIORITY APPLICATION(S)

This application claims priority under 35 U.S.C. § 119(e) to U.S. Provisional Patent Application No. 63/281,477, entitled “LUMBER GRABBER FOR AUTOMATED CRANE” filed on Nov. 19, 2021 (Attorney Docket No. IDFG 1010-1), which application is incorporated herein by reference.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves may also correspond to implementations of the claimed technology.

Processing timber involves a variety of tasks, such as stacking, moving, sawing, packaging, and shipping product and the like. During processing, timber is stacked and moved for grasping to various sizes and further processing in a timber mill or other facility. Often, large machines are used for this task. One problem with these traditional approaches is that the raw timber can be of various sizes and geometries, making the “pick and place” task difficult. The lack of flexibility is also compounded by the complexity of materials handling requirements for the timber. Rough cut timber is heavy and unwieldy, making the job of moving it into and out of the work area complex.

Conventional approaches to the problem of stacking timber are not flexible, nor scalable, nor cost effective, and are of very low efficiency, making their usage in scalable timber processing installations problematic. Often, conventional approaches require a variety of different inflexible “off the shelf” machines to perform the same task on different sizes of work product. Sometimes, conventional approaches require additional energy, human as well as machine, to be expended moving timber among a larger variety of machines to perform processing.

An opportunity arises to develop better machines and processes for positioning packages of lumber for processing into wood products. Better, more easily operated, more effective and efficient apparatus and systems may result.

### SUMMARY

A simplified summary is provided herein to help enable a basic or general understanding of various aspects of exemplary, non-limiting implementations that follow in the more detailed description and the accompanying drawings. This summary is not intended, however, as an extensive or exhaustive overview. Instead, the sole purpose of this summary is to present some concepts related to some exemplary non-limiting implementations in a simplified form as a prelude to the more detailed description of the various implementations that follow.

The technology disclosed relates to a lumber grabber for grasping timber. The lumber grabber can achieve grasping large packages of lumber of various work lengths (e.g., packages of between 7 feet and up to greater than 20 feet in length can be grasped and positioned by an automated crane appropriately equipped with a lumber grabber employing the disclosed technology). In one configuration, the lumber grabber includes moveable forks for grasping lumber movably supported by a frame, affixable to a crane. Forks positioned at ends of the frame and arranged to open and close relative to one other under power by a source of motive force; thereby enabling grasping and ungrasping of packages of timber under programmed control of a programmable controller executing stored instructions.

The technology disclosed relates to a lumber grabber for grasping timber. The lumber grabber can achieve grasping large packages of lumber of various work lengths (e.g., packages of between 7 feet and up to greater than 20 feet in length can be grasped and positioned by an automated crane appropriately equipped with a lumber grabber employing the disclosed technology). In one configuration, the lumber grabber includes a frame, a set of moveable carriages movably supported by the frame, two sets of forks, each set of forks positioned on one of the movable carriages at either end of the frame and arranged diametrically opposed to each other, a motor, a set of one or more rotatable ball screw shafts connected to and driven by the motor and to the carriages, to change relative positions of the carriages at either end of the frame; thereby enabling grasping and ungrasping of packages of timber under programmed control of a programmable controller executing stored instructions.

In one implementation, the lumber grabber is further equipped with a self-leveling device arranged such that when it rests on the units of lumber a slight slack rope condition is created in the crane to force the forks of the lumber grabber to level themselves to the lumber stacks. Various other combinations of work product length and fork dimensions can be implemented depending on requirements of the work site.

In a particular implementation, the technology disclosed also provides a method of grasping large packages of lumber of up to greater than 20 feet in length. The method can include lowering using a hoist of a crane a lumber grabber down to pick up a unit of lumber, wherein a movable plate attached to the lumber grabber via a hydraulic cylinder is in a fully down position due to gravity. As the hoist lowers, the plate will make contact with a top of the lumber unit, substantially contemporaneously with the hoist of the crane continuing to lower thereby creating a slack rope condition in the hoist. Opening valving on the hydraulic cylinder allows the lumber grabber to lower. Detecting using thru-beam photo sensors mounted near a rear base of forks on either side of the lumber grabber that the lumber grabber is in a clear position to close the forks to pick up the unit of lumber is also part of the method. Closing valves on the hydraulic cylinder when the lumber grabber lowered to a commanded height to pick up the unit of lumber. Height can be sensed using a laser ranging sensor as is known and commercially available, a vision system, other types of sensors, e.g., tactile, sonic, etc., or a combination of thereof. The method also includes commencing raising by the hoist of the crane the lumber grabber the unit of lumber when the forks are closed.

Particular aspects of the technology disclosed are described in the claims, specification and drawings.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 illustrates a perspective view of a lumber grabber for grasping timber.

FIG. 2A and FIG. 2B illustrate a front view of a lumber grabber for grasping timber in fully open and fully closed positions, respectively.

FIG. 3A and FIG. 3B illustrate a side view of a lumber grabber for grasping timber in fully open and fully closed positions, respectively.

FIG. 4A and FIG. 4B illustrate a top view of a lumber grabber for grasping timber in fully open and fully closed positions, respectively.

FIG. 5A and FIG. 5B illustrate a front view of another lumber grabber implementation in fully open and fully closed positions, respectively.

FIG. 6A and FIG. 6B illustrate a side view of another lumber grabber implementation in fully open and fully closed positions, respectively.

FIG. 7A and FIG. 7B illustrate a top view of another lumber grabber implementation in fully open and fully closed positions, respectively.

FIG. 8A illustrates a flowchart of actions for grasping timber with automated machinery like that of FIG. 1.

FIG. 8B illustrates a flowchart of actions for releasing grasped timber with automated machinery like that of FIG. 1.

FIG. 9A and FIG. 9B show implementation of an electronics architecture used by the lumber grabber in which a controller processes input data comprising at least actuation data from actuators of an actuation system, image data from visual sensors in the lumber grabber, and tactile data from tactile sensors in the lumber grabber, and generates actuator command data.

FIG. 10A and FIG. 10B illustrate detail views of latching mechanisms of a lumber grabber for locking the grabber in place when grasping timber.

FIG. 11 illustrates an example lumber processing facility in which a lumber grabber could be deployed.

### DETAILED DESCRIPTION

The following description will typically be with reference to specific structural embodiments and methods. It is to be understood that there is no intention to be limited to the specifically disclosed embodiments and methods, but that other features, elements, methods and embodiments may be used for implementations of this disclosure. Preferred embodiments are described to illustrate the technology disclosed, not to limit its scope, which is defined by the claims. Those of ordinary skill in the art will recognize a variety of equivalent variations on the description that follows. Unless otherwise stated, in this application specified relationships, such as parallel to, aligned with, or in the same plane as, mean that the specified relationships are within limitations of manufacturing processes and within manufacturing variations. When components are described as being coupled, connected, being in contact or contacting one another, they need not be physically directly touching one another unless specifically described as such. Like elements in various embodiments are commonly referred to with like reference numerals.

A more sophisticated lumber grasping system and method is provided for improved efficiency in moving packages of lumber for processing into wood products. Implementations efficiently handle packages of lumber of approximately 8 to greater than 20 feet in length.

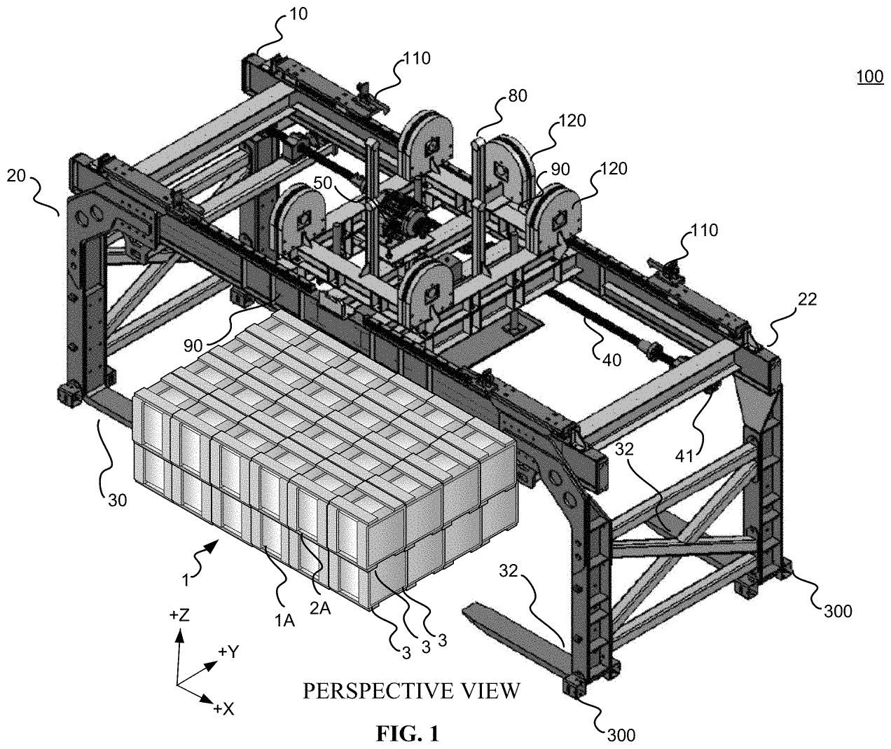

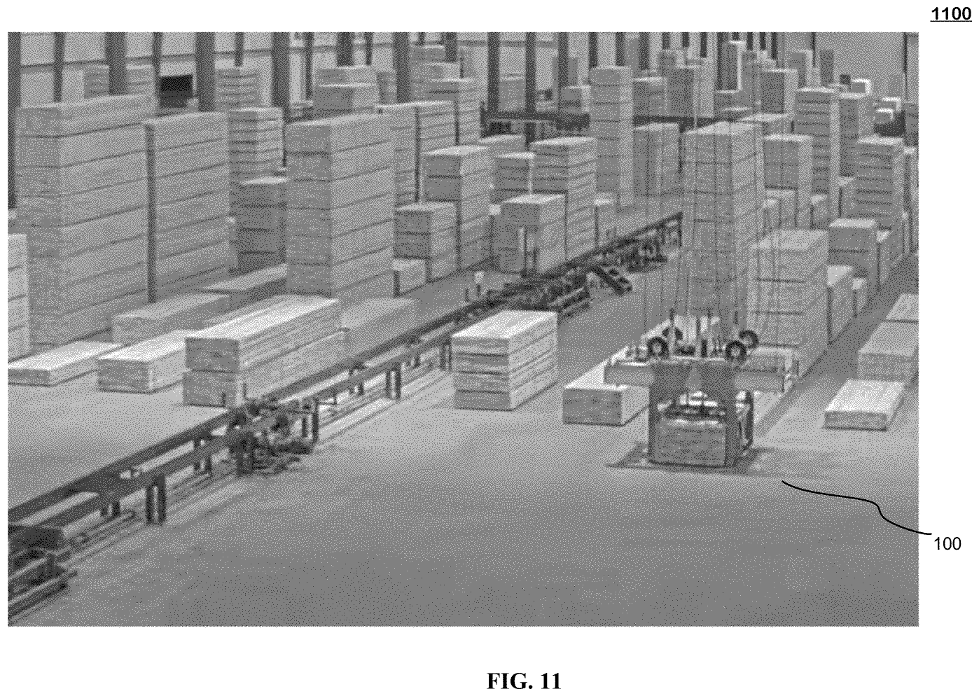

FIG. 1 illustrates a perspective view of a lumber grabber 100 for grasping timber. Lumber grabber 100 nominally includes a frame 10 configured to be attached to a crane (not shown in FIG. 1 for clarity sake) that can be affixed to the sawmill or warehouse floor (see e.g., FIG. 11). A crane can position the lumber grabber 100 as well as raise and lower the lumber grabber 100 into place by means of a plurality of cables connecting a lifting/lowering mechanism (e.g., a hoist, winch, etc.) of the crane (not shown in FIG. 1 for clarity) and crane cable sheaves 120 of the lumber grabber 100. Height above the work area is detected using a laser ranging sensor as is known and commercially available, a vision system, other types of sensors, e.g., tactile, sonic, etc., or a combination of sensors. A set of movable carriages 20, 22 are movably supported by the frame 10. Two sets of forks 30, 32 are positioned on one of the movable carriages 20, 22 at either end of the frame 10 and arranged to be approximately diametrically opposed to each other. A motor 50 is a source of motive force. A set of one or more rotatable ball screw shafts 40 connected to the motor 50 and to the movable carriages 20, 22, to change relative positions of the movable carriages 20, 22 with respect to one another. In some implementations, an absolute encoder 41 is connected to each ball screw 40 for position feedback. Motion of the movable carriages 20, 22 enables grasping and ungrasping of packages of lumber (e.g., workproduct 1) by forks 30, 32 under programmed control of a programmable controller (not shown) executing instructions stored on transitory, non-transitory readable media. In an implementation, a number of turns of the ball shaft and threading of the ball shaft is used to command the movable carriages 20, 22 to different distances. For example, in one implementation ball shafts move a carriage ½ inch per turn. Other configurations e.g., ¼ inch to 1 inch per turn can be used in some applications. In one implementation, the operating mechanism for opening and closing the lumber grabber is a single motor connected to two ball screws through belts and sheaves. In one implementation, both sides (e.g., carriages 20, 22) of the lumber grabber 100 are actuated substantially contemporaneously by action of the motor 50 and mechanical coupling (e.g., shafts 40, etc.). In another configuration, separate motors are used to drive each ball shaft.

Further, in one example implementation, each set of forks 30, 32 has a distance of travel of nominally 54″, however in some implementations, each set of forks has a travel distance in a range between 0 and 24 inches. In one example implementation, the forks open up to a width of nominally 108″ to drop down over a unit that is nominally 96″, however in some implementations, the sets of forks have an opening width in a range between 0 and 64 inches and some can accommodate lumber packages having a width in a range between 10 inches to 52 inches. This nominally allows 6″ of space on each side of the lumber units for the grabber to clear in one example implementation, however some applications may call for different amounts of clearance space on each side of the lumber units.

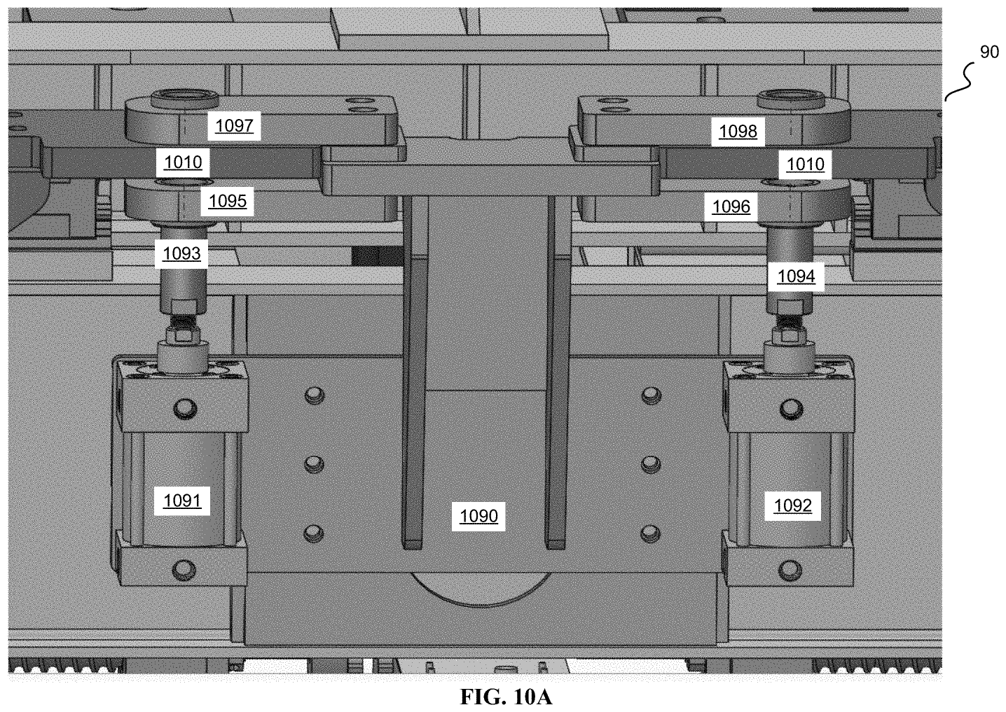

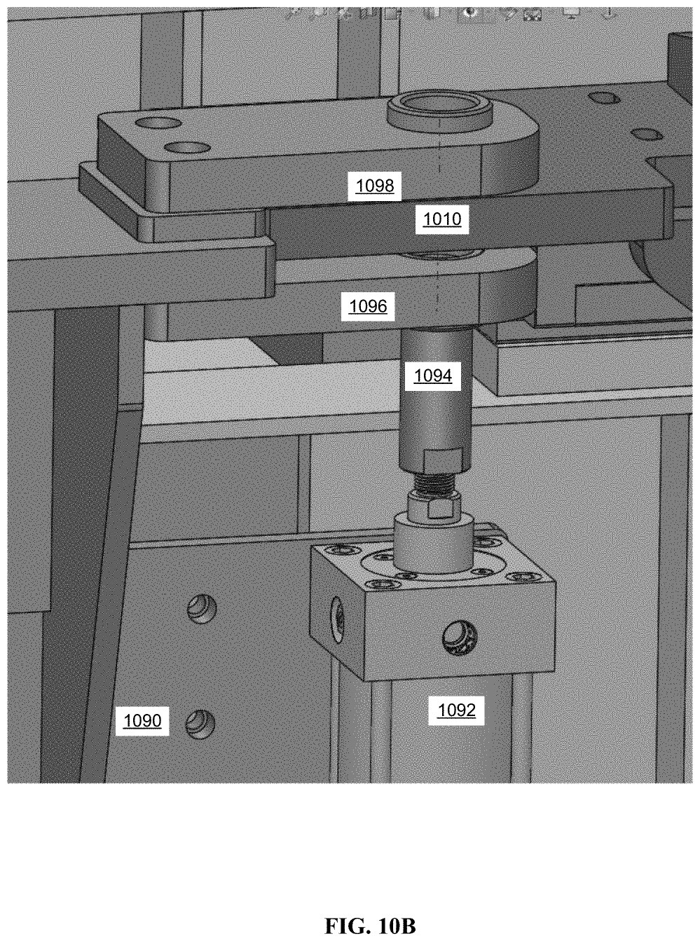

When the forks 30, 32 close on the unit of lumber, there are mechanical latches 90 that engage into slots 110 automatically under programmed control of a programmable controller (not shown). In the illustrated implementations, latches 90 are implemented using locking pins 1093, 1094 in FIG. 10A. These latches 90 lock the forks 30, 32 into place so that they cannot open during crane travel.

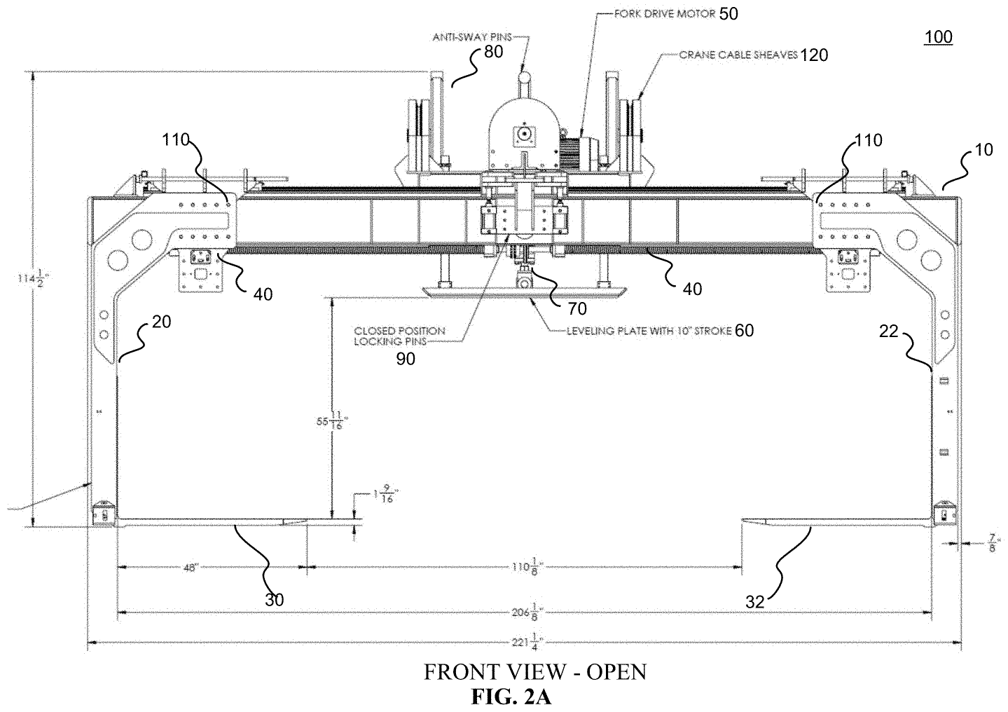

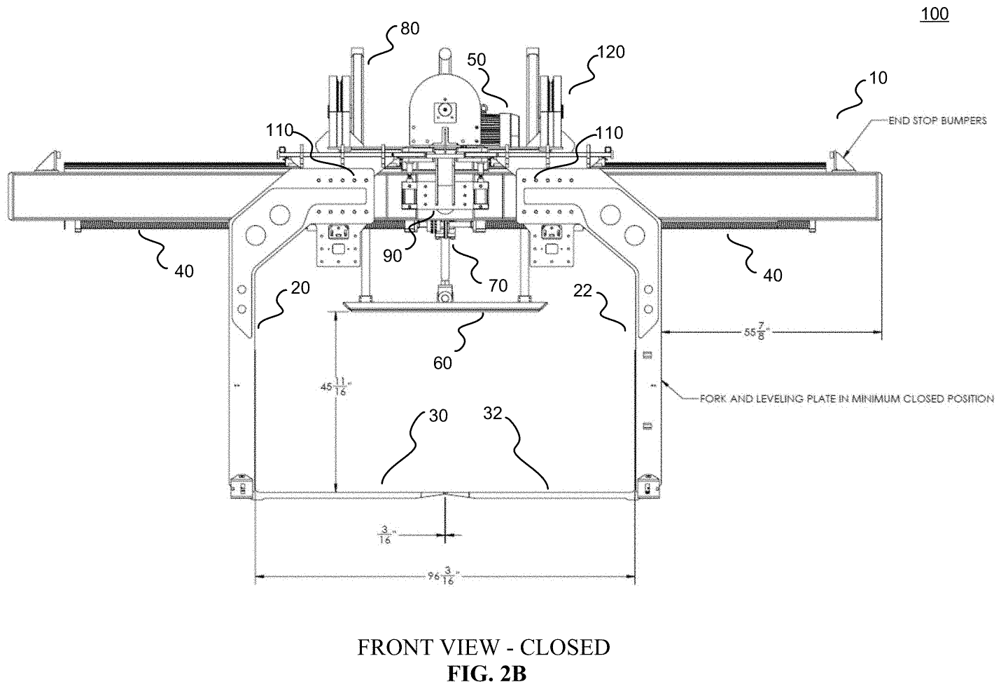

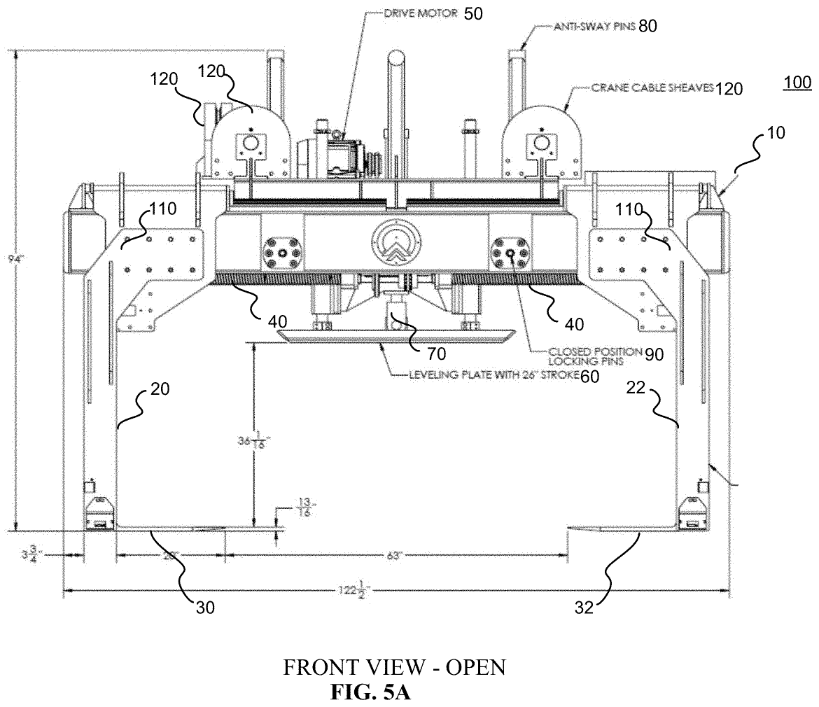

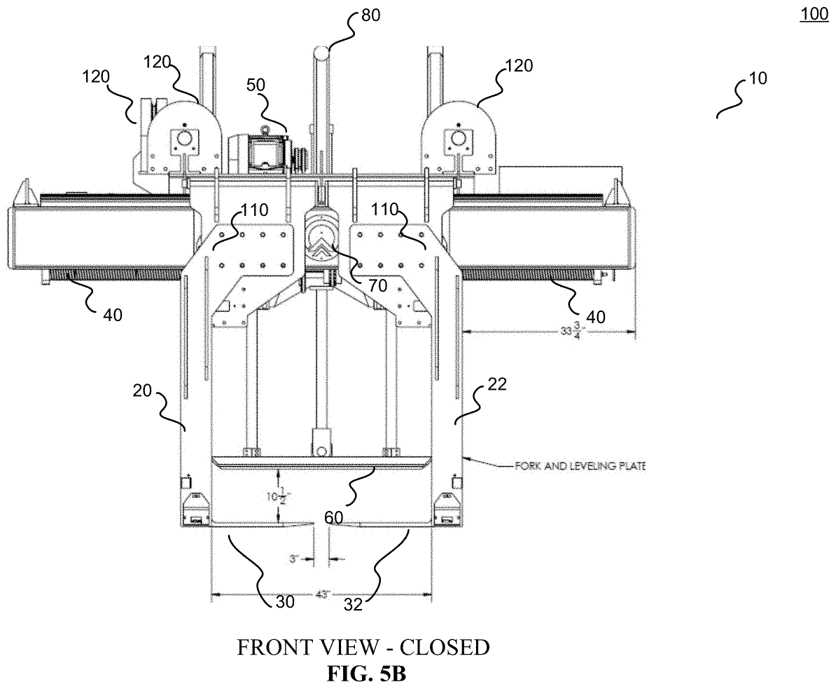

With continuing reference to FIG. 1, a nominal work product 1 is shown in relation to lumber grabber 100. Work product 1 comprises one or more layers 1A, 2A of lumber products stacked into a package. Dunnage 3 is interposed between the layers 1A and 2A as well as beneath the first or closest layer to the floor (or other surface on which the work product 1 is resting). Dunnage 3 enables forks 30, 32 to be slide beneath a layer of work lumber in order to grasp and lift the lumber. In one example described with reference to FIGS. 5A, 5B, 6A, 6B, 7A, 7B, and 11, a lumber grabber configuration is described that is suitable for use with work product comprising dry finished lumber from 12 inches to 24 inches tall×44 inches wide×from 8 feet to 20 feet long. In another example described with reference to FIGS. 2A, 2B, 3A, 3B, 4A, and 4B, a lumber grabber configuration is described that is suitable for use with work product comprising green lumber of 54 inches tall×8 feet wide×from 8 feet to 20 feet long. In some example applications, finished lumber product packages employ dunnage of from 1 inch to 1.5 inches thick, and green lumber product packages employ dunnage of 3.5 inches thick.

FIG. 2A and FIG. 2B illustrate a front view of a lumber grabber for grasping timber in fully open and fully closed positions, respectively.

A self-leveling device comprised of a plate 60 is positioned so that when the plate 60 rests on a unit of lumber (not illustrated) a slight slack rope condition is created in a crane to which the lumber grabber frame 10 is attached, to force the forks 30, 32 of the lumber grabber 100 to level themselves to the unit of lumber. A hydraulic cylinder 70 is attached to the plate 60, enabling height of the plate 60 to be set by allowing hydraulic fluid to flow out of a cylinder 70 as it is compressed until a hoist of the crane reaches a commanded position. In one implementation, the commanded position can be provided by a PLC controller and Inventory Management system that tracks locations and dimensions of units of lumber in a warehouse.

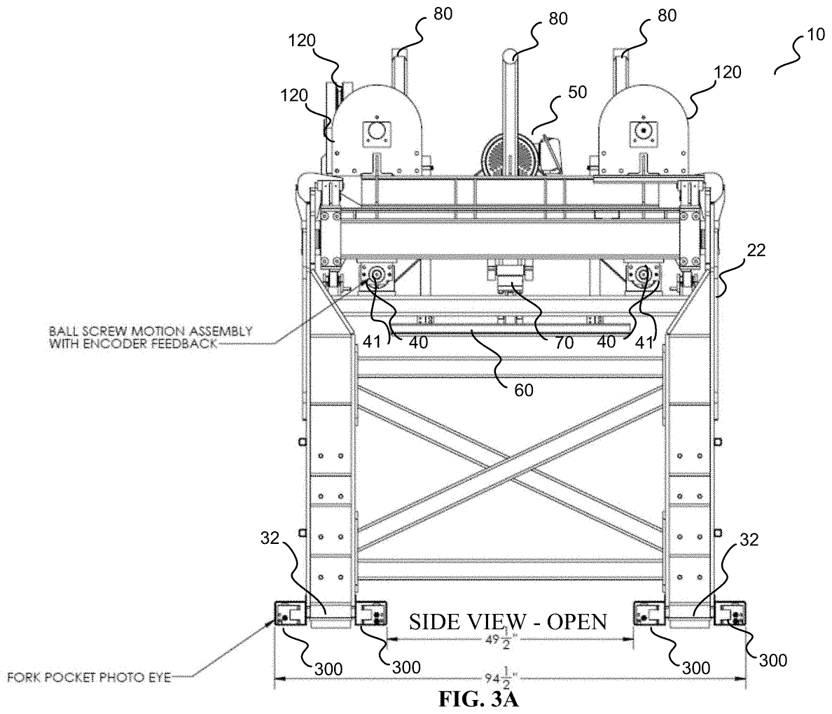

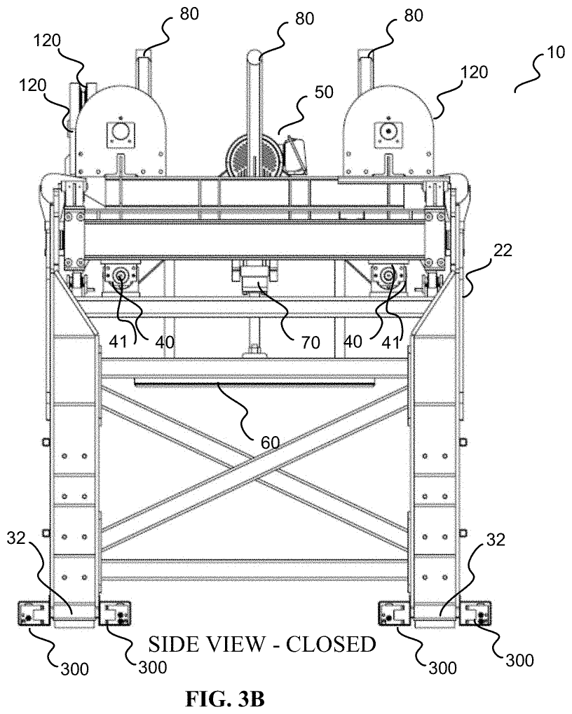

In one implementation, the exact height of the unit of lumber is further measured with a vision system for verification. When the hoist is lowering lumber grabber 100 down to pick up a unit of lumber, the plate 60 is in its fully extended (down) position due to gravity. As the hoist lowers the lumber grabber, the plate 60 makes contact with the top of the lumber unit. The hoist of the crane will continue to lower the lumber grabber creating a slack rope condition. Valving (not shown for clarity sake) on the hydraulic cylinder 70 will open allowing the lumber grabber 100 to be lowered. In some implementations, thru-beam photo-sensors 300 mounted near the rear base of the forks of the grabber (See e.g., FIG. 3A and FIG. 3B). The photo-sensors 300 indicate to the controller that the lumber grabber 100 is in a clear position to close the forks 30, 32 to pick up the unit of lumber. When the lumber grabber 100 is lowered to the commanded height to grasp a unit of lumber, the valves are closed. Once the forks 30, 32 are closed the hoist begins to raise the lumber grabber 100.

When the forks 30, 32 close on the unit of lumber, there are mechanical latches 90 that engage into slots 110 automatically under programmed control of a programmable controller (not shown). In the illustrated implementations, latches 90 are implemented using locking pins as is shown in FIGS. 10A and 10B. These latches 90 lock the forks 30, 32 into place so that they cannot open during crane travel. In some implementations, an absolute encoder 41 (of FIG. 3A and FIG. 3B) is connected to each ball screw for position feedback. One or more extreme open and closed proximity switch(es) can further be used for double verification of fork position. These devices are used by the control system to make decisions as to when it is safe to (i) raise, (ii) lower, or (iii) travel in a horizontal direction with the crane. While the crane is holding the unit of lumber there are load cells (not shown) on the crane that measure the unit weight. When the load measured falls below a threshold, e.g., near zero or the weight of slack cabling, it is known that the lumber grabber is resting on the payload.

In this implementation, the motor is controlled by a Variable Frequency Drive that resides in the main control panel (not illustrated for clarity's sake). Motor 50 is electrically driven using power conducted by cabling from a source and dropped in overhead or via conduits through walls or flooring and can nominally output 7.5 hp. Motors having power outputs in a range of 5 to 150 horsepower can be used in some implementations. One lumber grabber configuration described with reference to FIGS. 2A, 2B, 3A, 3B, 4A, and 4B is suitable for use with work product comprising green lumber of 54 inches tall×8 feet wide×from 8 feet to 20 feet long. One particular embodiment of the lumber grabber is designed for packages of lumber that are nominally 96 inches, but some implementations can accommodate packages between 24 and 52 inches wide and varying in length from 7 feet to 20 feet or greater and has a payload range that includes a payload of 0 pounds (lbs) to up to 35,000 pounds (lbs.).

FIG. 3A and FIG. 3B illustrate a side view of a lumber grabber for grasping timber in fully open and fully closed positions, respectively. In the configuration illustrated by FIG. 3A and FIG. 3B, thru-beam photo-sensors 300 are mounted near the rear base of the forks of the grabber (See e.g., FIG. 3A and FIG. 3B). The photo-sensors 300 indicate to the controller that the lumber grabber 100 is in a clear position to close the forks 30, 32 to pick up the unit of lumber.

In the frame 10 are pins 80 that project up vertically. These pins 80 lock into some receiving points on the crane trolley (not shown) itself to lock the lumber grabber 100 package into place during travel. This ensures that the unit will not sway during travel therefore making the cycle times much faster as the system does not have to wait for the load to settle when the destination of the crane is reached. This will also ensure the highest degree of accuracy when picking and placing units of lumber, as the sway of the grabber will be minimal if being hoisted down from a locked in position.

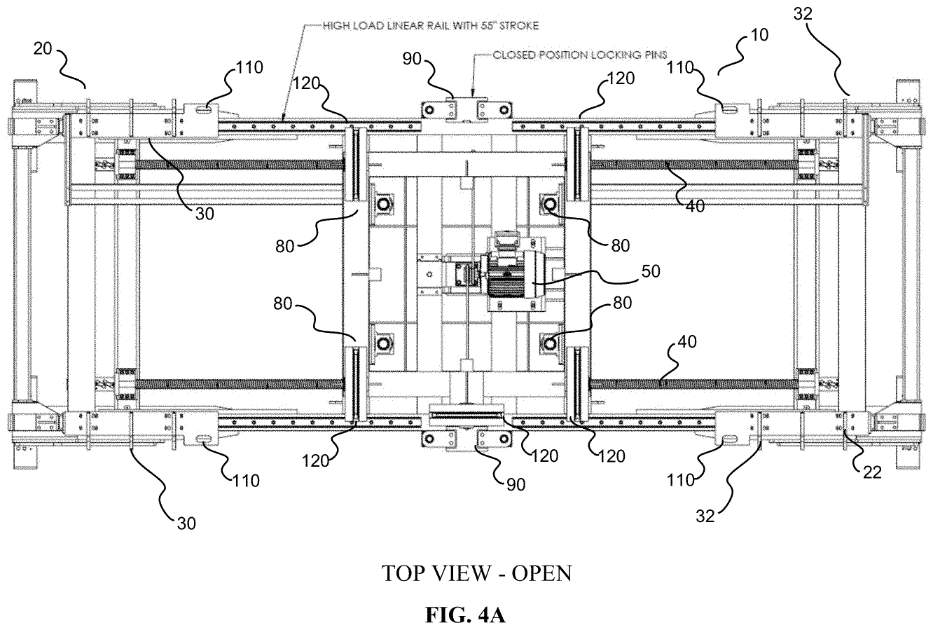

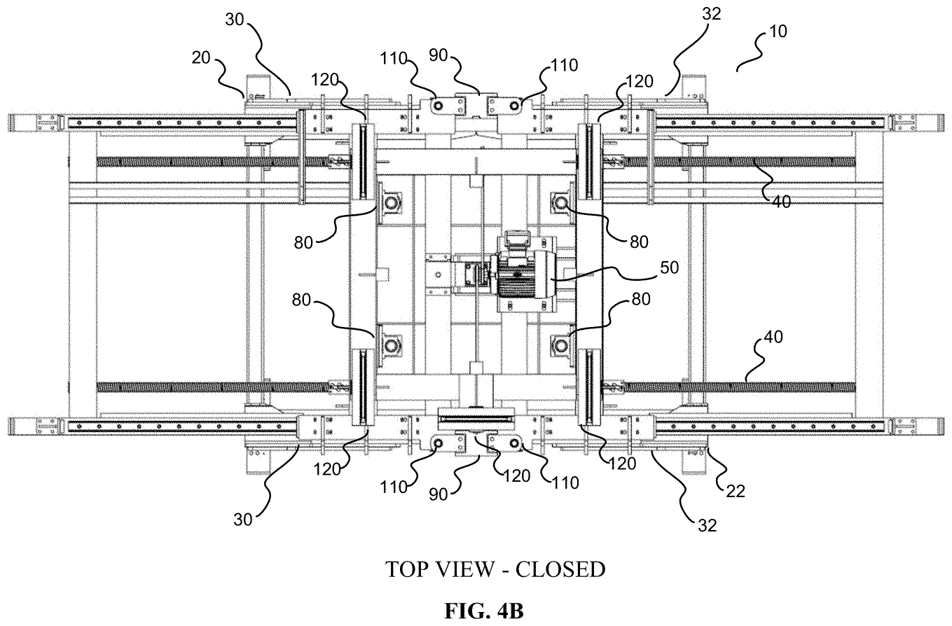

FIG. 4A and FIG. 4B illustrate a top view of a lumber grabber for grasping timber in fully open and fully closed positions, respectively. In the top view of frame 10, pins 80 that project up (+z axis is out of the page in FIG. 4A and FIG. 4B) vertically are depicted in relation to the frame 10 and other components of the lumber grabber 100. These pins 80 lock into some receiving points on the crane trolley (not shown) itself to lock the lumber grabber 100 package into place during travel.

FIG. 5A and FIG. 5B illustrate a front view of another lumber grabber implementation in fully open and fully closed positions, respectively. The lumber grabber implementation illustrated by FIGS. 5A, 5B, 6A, 6B, 7A 7B, and 11 is dimensionally smaller than the lumber grabber illustrated by FIGS. 2A, 2B, 3A, 3B, 4A, and 4B, and suited for use in warehouses containing finished product in which the packages are smaller than the rough cut lumber products handled by the larger lumber grabber, thereby enabling users to conserve space and increase the amount of inventory that can be kept in the warehouse. One lumber grabber implementation described with reference to FIGS. 5A, 5B, 6A, 6B, 7A, 7B and 11 is suitable for use with work product comprising dry finished lumber from 12 inches to 24 inches tall×44 inches wide×from 8 feet to 20 feet long. FIG. 11 illustrates an example lumber processing facility in which such a lumber grabber could be deployed.

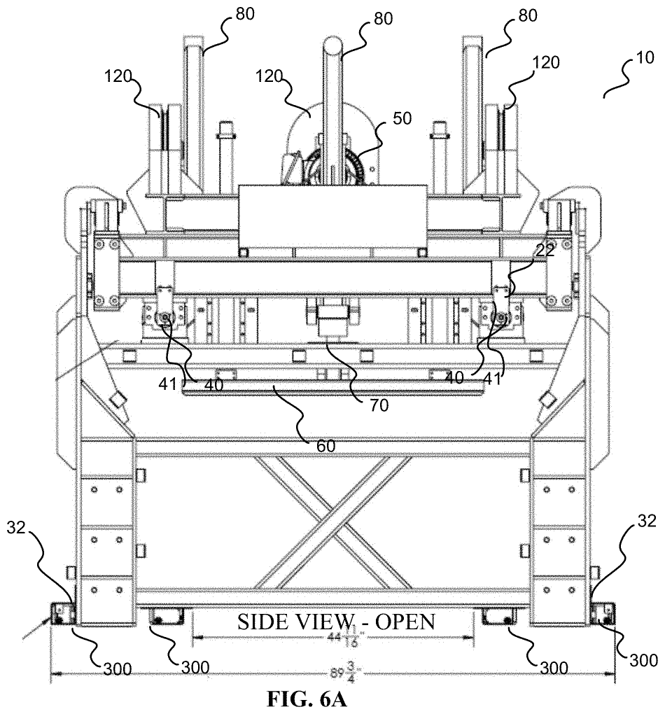

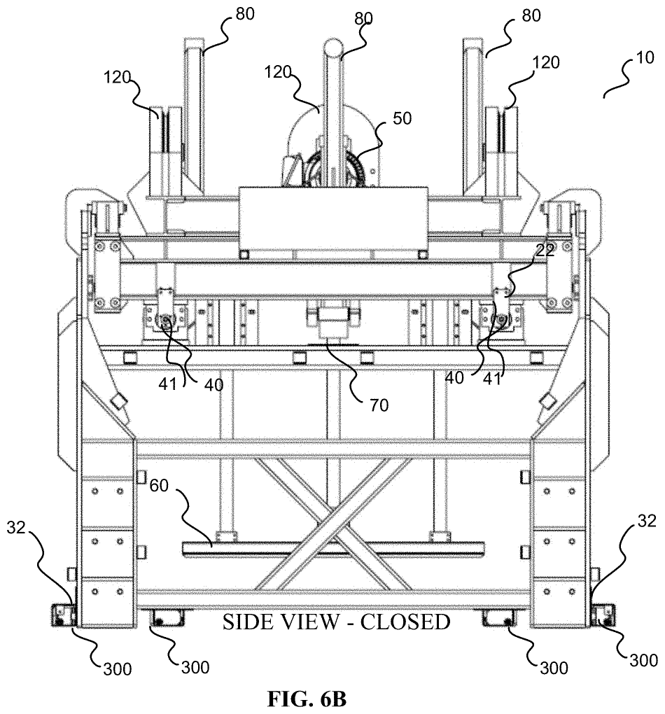

FIG. 6A and FIG. 6B illustrate a side view of another lumber grabber implementation in fully open and fully closed positions, respectively.

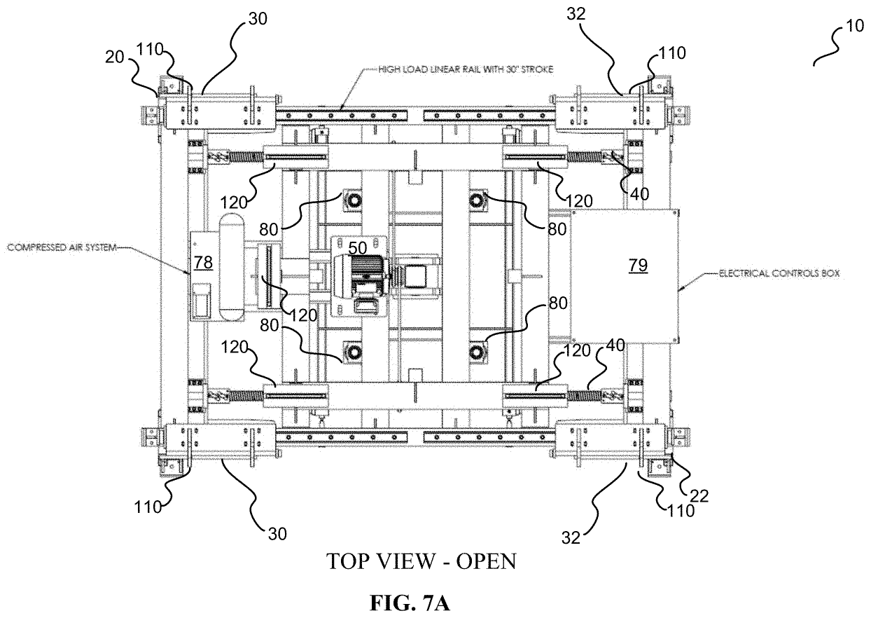

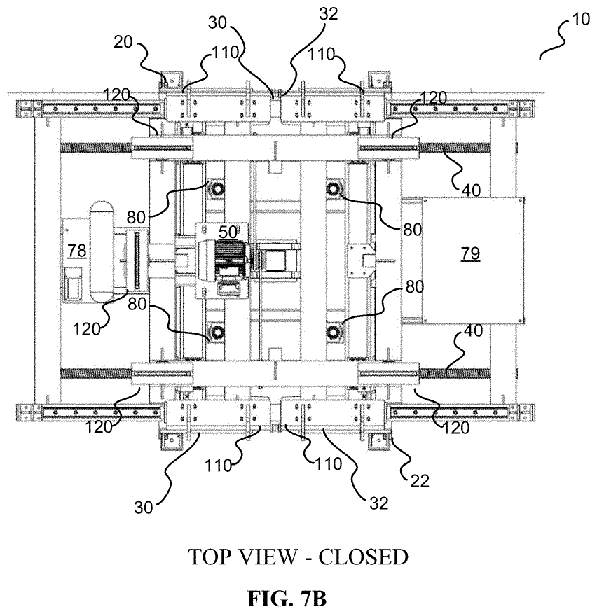

FIG. 7A and FIG. 7B illustrate a top view of another lumber grabber implementation in fully open and fully closed positions, respectively. A compressed air system 78 provides the actuating force for the locking pins/latches 90 that prevent the forks from opening when traveling while carrying a load of lumber products. An electronics box 79 contains remote input/output (TO) ports for the programmable logic controller (PLC) and provides a point where the sensors on the grabber are wired into.

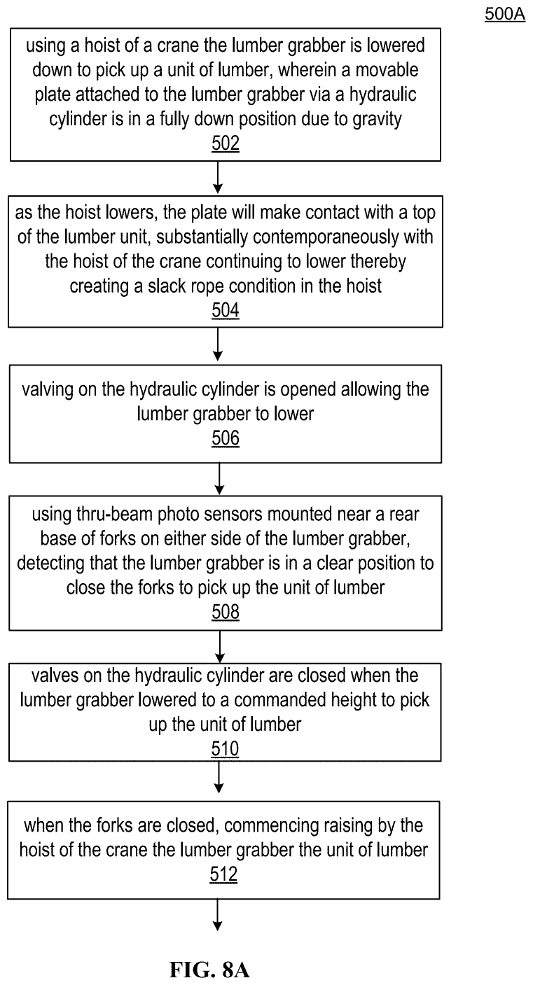

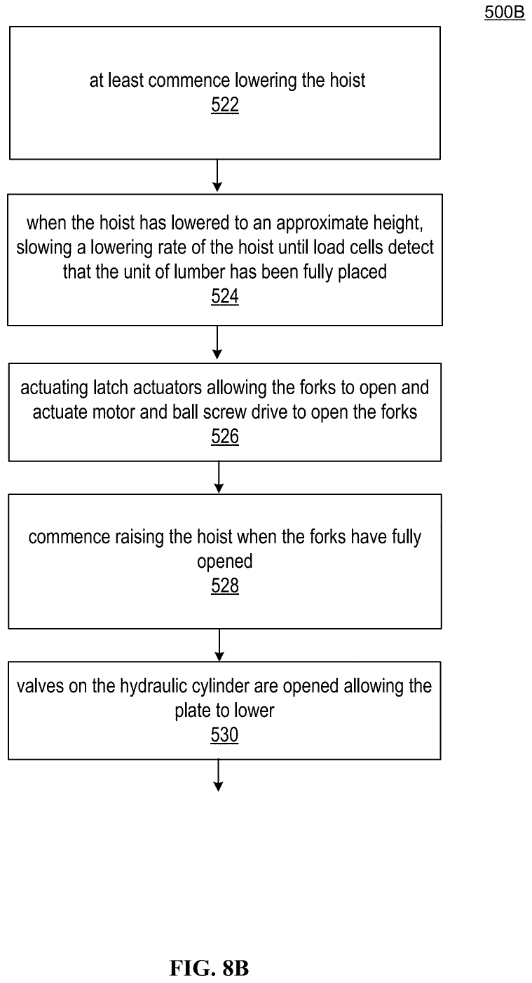

FIG. 8A illustrates a flowchart of actions for grasping timber with automated machinery like that of FIG. 1. The machinery is not necessarily part of the method.

In a block 502, using a hoist of a crane the lumber grabber is lowered down to pick up a unit of lumber, wherein a movable plate attached to the lumber grabber via a hydraulic cylinder is in a fully down position due to gravity.

In a block 504, as the hoist lowers, the plate will make contact with a top of the lumber unit, substantially contemporaneously with the hoist of the crane continuing to lower thereby creating a slack rope condition in the hoist.

In a block 506, valving on the hydraulic cylinder is opened allowing the lumber grabber to lower.

In a block 508, using thru-beam photo sensors mounted near a rear base of forks on either side of the lumber grabber, detecting that the lumber grabber is in a clear position to close the forks to pick up the unit of lumber.

In a block 510, valves on the hydraulic cylinder are closed when the lumber grabber lowered to a commanded height to pick up the unit of lumber.

In a block 512, when the forks are closed, commencing raising by the hoist of the crane the lumber grabber the unit of lumber. Some implementations employ compressed air as the actuating force for the locking pins or latches 90 that prevent the forks from opening when traveling under load. In other implementations, latches 90 can be actuated by hydraulic pressure, or electrical energy as in the case of solenoids or servomotors.

Other implementations of the method described in this section can include a non-transitory computer readable storage medium storing instructions executable by a processor to perform any of the methods described above. Yet another implementation of the method described in this section can include a system including memory and one or more processors operable to execute instructions, stored in the memory, to perform any of the methods described above.

FIG. 8B illustrates a flowchart of actions for releasing grasped timber with automated machinery like that of FIG. 1. The machinery is not necessarily part of the method.

In a block 522, lowering the hoist is commenced.

In a block 524, when the hoist has lowered to an approximate height, e.g., as detected by a proximity to surface sensor such as a laser ranging device/sensor, vision system, or other types of sensors, e.g., tactile, sonic, etc., or the like or a combination of thereof, a lowering rate of the hoist is slowed until load cells (sensors on the crane) detect that loading on the cable suspending the lumber grabber has fallen to/below a threshold, indicating that the unit of lumber has been fully placed.

In a block 526, latch actuators are actuated, allowing the forks to open and the motor and ball screw drive are actuated to open the forks.

In a block 528, raising the hoist is commenced when the forks have fully opened.

In a block 530, the hydraulic valve is opened allowing the plate to lower.

Other implementations of the method described in this section can include a non-transitory computer readable storage medium storing instructions executable by a processor to perform any of the methods described above. Yet another implementation of the method described in this section can include a system including memory and one or more processors operable to execute instructions, stored in the memory, to perform any of the methods described above.

Additional features included in various implementations of the lumber grabber workstation 100 include the use of sensors such as (i) 2-axis inclinometer mounted on each grabber frame to measure the tilt in the x and y direction. This is a safety device to ensure that if the grabber frame is to catch on anything at any time during the automated process that the tilt would be captured and cause an Emergency Stop condition for the crane, (ii) current transducers allowing the motor to dynamically adjust the speed of the down motion and (ii) area sensors for detection of entry into a danger zone. Additionally, the cycle time per grasp and transport can vary based on package size and motor size, where the lumber grabber 100 is capable of adapting to various motor sizes, depending on current requirements of the mill. Motors can be changed or swapped based on various requirements. The components of lumber grabber 100 (e.g., frame, forks, etc.) and crane size can be selected and implemented based on the requirements (e.g., volume throughput) of the mill. The travel speed of the lumber grabber (e.g., 10 inches per second) as it is grasping can be adjusted based on the dimensions of the work pieces/products and requirements of the mill. This information is calculated and then passed from a programmable logic controller (PLC) to each of the cranes for initial positioning and subsequent grasping.

### Electronics Architecture

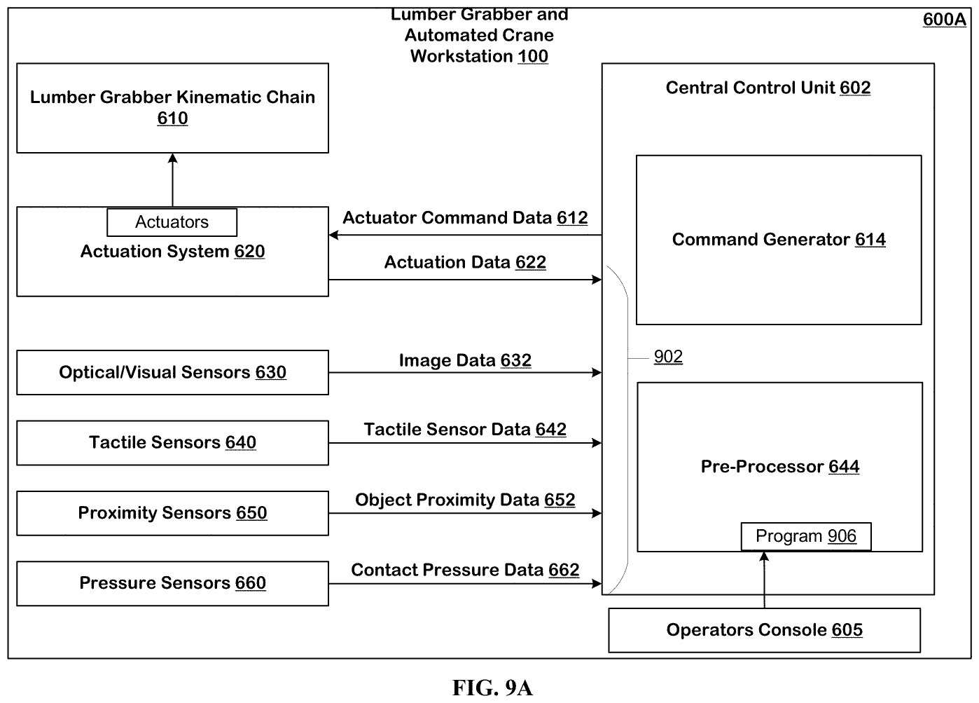

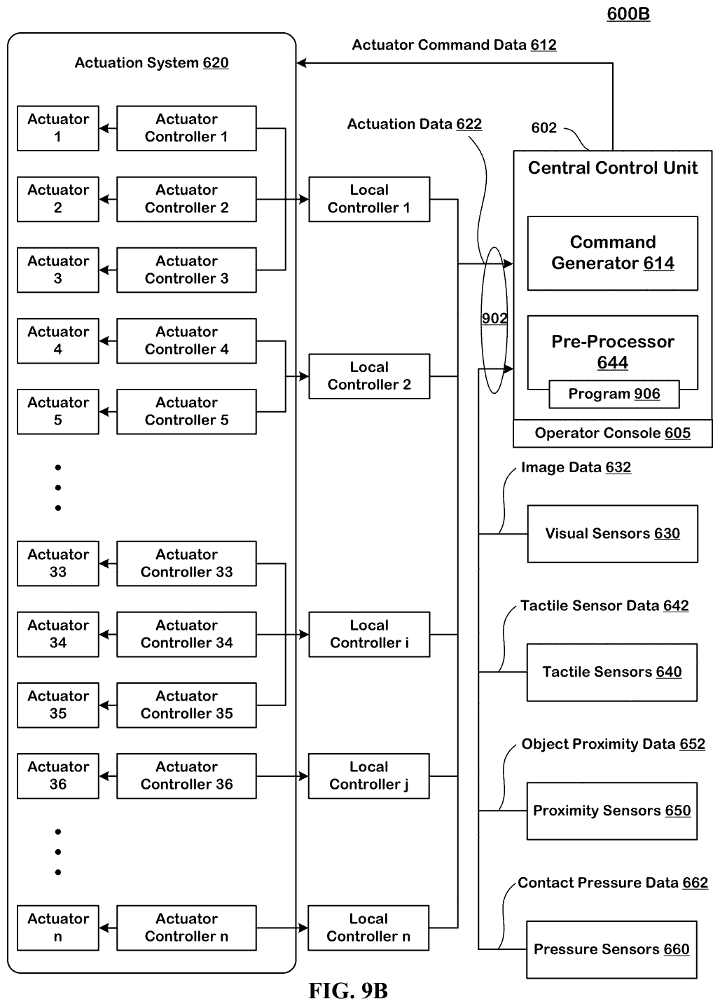

FIG. 9A is a simple functional block diagram of an electronics architecture suitable for implementing the lumber grabber workstation 100. In FIG. 9A, the electronics architecture 600A comprises the central control unit 602 that controls the actuators (e.g., that control manipulators, such as the movable carriages/forks of the lumber grabber workstation 100) including sources of motive force (e.g., motor 50) and, therefore the linkages, joints, and forks/end effectors, etc. of the lumber grabber 100, using the command generator 614 and/or the pre-processor 644.

The lumber grabber workstation 100 includes the kinematic chain 610, and the actuation system 620. The lumber grabber 100 includes a central control unit 602 (i.e., controller) that in this example comprises a command generator 614 and a pre-processor 644. The controller is in communication with the plurality of actuators and the sensors, and operates the components on the kinematic chain. The controller includes a feedback loop receiving feedback data derived from or including the actuator data and sensor data as feedback input, trained to generate actuator command data 612 to cause the lumber grabber workstation 100 to execute a task to manipulate the object responsive to the feedback data, under direct operator control and/or by programmed logic. Implementation specifics vary considerably, however in one example a Controllogix™ PLC is used to implement the central control unit 602. Training may be implemented using programming by an operator at operators console 605. In other embodiments, machine learning algorithms and techniques are used to generate, or augment existing, commands to the lumber grabber workstation 100.

The actuation system 620 can include sources of motive force, e.g., electric motors, hydraulic cylinders, pneumatic cylinders and the like, coupling actuators, e.g., linkages, springs, levers, and so forth, and sensors affixed to one or the other, e.g., encoders, position sensors, combinations thereof, or the like. The actuation system 620 provides actuation data 622 to the central control unit 602, and receives actuator command data 612, including actuator commands, from the central control unit 602. Also, the lumber grabber 100 includes as describe above, optical/visual sensors 630 generating image data 632 and range data, tactile sensors 640 in this example generating tactile sensor data 642, proximity sensors 650 in this example generating object proximity data 652 relative to the end effectors, and pressure sensors 660 in this example generating contact pressure data 662. The actuation data 622, the image data 632, the tactile sensor data 642, the object proximity data 652, and the contact pressure data 662 are provided to the central control unit 602.

The command generator 614 can plan motion of components of the lumber grabber 100, such as the movable carriages of the lumber grabber 100 and use this motion plan to generate a sequence of commands commanding the joints of the lumber grabber 100 for the purposes of advancing the lumber grabber 100 to a goal state provided by the pre-processor 644 to the command generator 614.

The pre-processor 644 can process the actuation data 622, the image data 632, the tactile sensor data 642, the object proximity data 652, and the contact pressure data 662 to produce a state vector for the lumber grabber 100. This state vector is produced in a time frame and manner as needed to control the state of the lumber grabber 100 and is accessible to task programming provided to the lumber grabber 100 via the operators console 605. The pre-processor 644 can include one or more trained neural networks used for the purpose of deriving feedback data for input the neural network that generates the command data. Also, the command generator can include one or more trained neural networks. In some implementations, the command generator and the pre-processor comprise neural networks trained end-to-end using reinforcement learning. Other training procedures can be applied as well, including separate training of the neural networks in the controller.

Thus, the central control unit 602 processes input data comprising at least the actuation data 622 from the actuators of the actuation system 620, the image data 632 from the visual sensors 630 if present, and if present, other sensor data such as the tactile sensor data 642 from the tactile sensors 640 of the lumber grabber 100 and generates actuator command data 612.

In some implementations, with reference to FIG. 9B, the electronics architecture 600B further comprises distributed local controllers that are responsible for low-level motor control, including current, velocity, and position control, evaluation of the joint sensors, output control signals to the actuator power electronics, parameterization of the actuator controllers, e.g., for gain scheduling, and data acquisition from the force/torque sensors and inertial measure measurement system. Each local controller can handle a set of actuators (e.g., one, two, or three actuators). Cable harnesses connect the actuator sensors, actuators, drives to the local controllers. The central control unit 602 and the local controllers can communicate by a high speed communication interface such as CAN, FireWire, Ethernet/IP, or SERCOS, supporting real-time control in which each new set of actuator commands is based on feedback data that indicates the effects of the immediately preceding command set on the state of the lumber grabber 100 and the object of the task.

### Controller

The central control unit 602 includes the command generator 614 and the pre-processor 644, in this example, implementing a control loop that includes processing the input data for an instant time interval, and generating the actuator command data 612 for use in a next time interval.

The central control unit 602 is also configured with a system file including a program file (e.g., program file 906) that specifies the task(s) to be executed by the lumber grabber 100. The program file can identify the task in a sequence of sub-tasks, along with goal positions, goal angles, maximum and minimum values for sampling the goal positions and the goal angles, policy paths and trajectories, policy speedup coefficients, and feedback actions. Each “task” can be implemented to be triggered based upon a set of detected input conditions, duty cycle, operator command issued at the operators console 605 or otherwise. In one implementation, a set of weights generated by training a neural network system, including a trained neural network in a feedback loop receiving feedback data derived from or including the actuator data and the sensor data as feedback input, trained to generate actuator command data to cause the automata to execute the task to manipulate the object, or the automata in preparation for manipulation of an object, in response to the feedback data. The neural network system that can be trained using reinforcement learning algorithms and configured with a policy that implements the control feedback loop. The neural network system can use neural networks like a multi-layer perceptron (MLP), a feed-forward neural network (FFNN), a fully connected neural network (FCNN), a convolutional neural network (CNN), and a recurrent neural network (RNN). Example of the reinforcement learning algorithms include deterministic policy gradient algorithms, and policy-gradient actor-critic algorithms like deep deterministic policy gradient (DDPG) with hindsight experience replay (HER) and distributed distributional deterministic policy gradient (D4PG).

The input data 902 can includes the range image data 632 from the visual sensors 630 indicating the orientation and position of the timber and the lumber grabber 100 in three dimensions and time, and the actuation data 622 from the actuators of the actuation system 620. The input data 902 can further include the tactile sensor data 642 from the tactile sensors 640 in the lumber grabber 100 or other components of the lumber grabber 100. The input data 902 can further include the object proximity data 652 from the proximity sensors 650. The input data 902 can further include the contact pressure data 662 from the pressure sensors 660. The input data 902 can further include external motion tracking data from an external, stand-alone motion tracking system like OptiTrack™ type motion capture system that tracks motion of the lumber grabber 100 and the object in a three-dimensional space. The input data 902 can be used as feedback data in the feedback loop, and can be used to derive feedback data, and both.

The actuator command data 612 updates one or more of the actuator parameters of the actuators. Examples of the actuator command data 612 include position updates, absolute positions, angle updates, absolute angles, torque updates, absolute torques, speed updates, absolute speeds, velocity updates, absolute velocities, acceleration updates, absolute accelerations, rotation updates, and absolute rotations. The actuator command data 612 is used to update the respective states of the actuators in the next time interval, which in turn causes the tendons, the joints, the body parts, and other components of the lumber grabber 100 to transition to a different state (e.g., tension, position, orientation) in the next time interval.

The actuator command data 612 can include commands for each of the actuators or only a subset of the actuators. Each command can include an actuator ID, and a numerical value or values used to drive the actuator to a next state.

In the implementation listed above, the actuator command data 612 provided as output of the controller comprising a vector of drive changes for differential positioning, or a vector of position mode target positions, or a vector of force/torque values, and various combinations of differential mode commands, position mode command as suitable for the actuators under control.

The actuators execute the commands specified in the actuator command data 612 and generate the actuation data 622 for the next time interval, and cause generation of the image data 632 by the visual sensors 630 and the tactile sensor data 642 by the tactile sensors 640 for the next time interval. The process is iterated by the control loop implemented by the controller 630.

In some implementations, the actuator command data 612 generated by the controller 602 is processed by a calibration module (not shown) that generates a calibrated version of the actuator command data 612 which is specific to the configuration of the lumber grabber 100. The calibrated version of the actuator command data is used to update the respective states of the actuators.

Additional features included in various implementations of the lumber grabber 100 include the use of sensors such as (i) encoders for movement measurement of various components of the lumber grabber 100; (ii) current transducers allowing the system to automatically detect a stall or jamb condition of the lumber grabber 100 and signal for assistance; and (ii) area sensors for detection of entry into a danger zone.

### Latching Mechanisms

FIG. 10A and FIG. 10B illustrate detail views of latching mechanisms of a lumber grabber for locking the grabber in place when grasping timber. Latching mechanism 90 shown in FIGS. 10A and 10B is suitable for implementing latching functionality that holds moveable forks 30, 32 in place when lumber is grasped. As shown, latching mechanism 90 can include a mounting base 1090 having a pair of actuators 1091, 1092 affixed thereto. Actuators 1091, 1092 can be implemented using electrically operated solenoids or servo motors, or hydraulically actuated cylinders or pneumatic cylinders. Each of actuators 1091, 1092 is mechanically coupled to a locking pin 1093, 1094, enabling the locking pins 1093, 1094 to be extended into or withdrawn from engaging slotted members 1010 of moveable carriages 20, 22 through guide members 1095, 1097 and 1096, 1098 respectively. In a present embodiment, locking pins 1093, 1094 include a 45-degree chamfer on their top surface to facilitate locating a slot 110 in slotted members 1010. Other angles e.g., from 10 degrees to 70 degrees are also suited for chamfering the surface of locking pins 1093, 1094.

### Some Particular Implementations

We describe various implementations of lumber grabber workstation.

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

A system implementation of the technology disclosed includes a lumber grabber for grasping timber. The lumber grabber can achieve grasping large packages of lumber of up to greater than 20 feet in length. In one configuration, the lumber grabber 100 includes a frame, a set of movable carriages movably supported by the frame, two sets of forks, each set of forks positioned on one of the movable carriages at either end of the frame and arranged diametrically opposed to each other, a motor, a set of one or more rotatable ball screw shafts connected to and driven by the motor and to the movable carriages, to change relative positions of the movable carriages at either end of the frame; thereby enabling grasping and ungrasping of packages of lumber under programmed control of a programmable controller executing stored instructions.

This system implementation and other systems disclosed optionally include one or more of the following features. System can also include features described in connection with methods disclosed. In the interest of conciseness, alternative combinations of system features are not individually enumerated. Features applicable to systems, methods, and articles of manufacture are not repeated for each statutory class set of base features. The reader will understand how features identified in this section can readily be combined with base features in other statutory classes.

One lumber grabber workstation implementation further includes a self-leveling device comprised of a plate positioned so that when the plate rests on a unit of lumber a slight slack rope condition is created in a crane to which the lumber grabber frame is attached, to force the forks of the grabber to level themselves to the unit of lumber.

In one lumber grabber workstation implementation, a hydraulic cylinder attached to the plate, enabling height of the plate to be set by allowing hydraulic fluid to flow out of a cylinder as it is compressed until a hoist of the crane reaches the commanded position.

In one lumber grabber workstation implementation, the commanded position is given by a PLC controller and Inventory Management system that tracks locations and dimensions of units of lumber in a warehouse.

One lumber grabber workstation implementation further includes a vision system that measures an exact height of the unit of lumber for verification.

One lumber grabber workstation implementation further includes thru-beam photo sensors mounted near the rear base of the forks to tell the programmable controller that the frame is in a clear position to close the forks to pick up the unit of lumber.

In one lumber grabber workstation implementation, a payload range includes a payload of up to 35,000 pounds (lbs).

In one lumber grabber workstation implementation, a width of lumber packages movable by the lumber grabber workstation is in a range between 72 inches to 96 inches.

In one lumber grabber workstation implementation, each set of forks has a travel distance in a range between 0 and 54 inches.

In one lumber grabber workstation implementation, the sets of forks have an opening width in a range between 0 and 108 inches.

In one lumber grabber workstation implementation, further includes mechanical latches that engage into slots automatically locking forks into place so that the forks cannot open during crane travel.

In one lumber grabber workstation implementation, further includes a set of absolute encoders, each connected to each ball screw to provide position feedback.

In one lumber grabber workstation implementation, further includes an extreme open and closed proximity switch for double verification of fork position.

A method implementation of the technology disclosed includes a method of grasping packages of lumber of 8 feet up to greater than 20 feet in length. The method can include lowering using a hoist of a crane a lumber grabber down to pick up a unit of lumber, wherein a movable plate attached to the lumber grabber via a hydraulic cylinder is in a fully down position due to gravity. As the hoist lowers, the plate will make contact with a top of the lumber unit, substantially contemporaneously with the hoist of the crane continuing to lower thereby creating a slack rope condition in the hoist. Opening valving on the hydraulic cylinder allows the lumber grabber to lower. Detecting using thru-beam photo sensors mounted near a rear base of forks on either side of the lumber grabber that the lumber grabber is in a clear position to close the forks to pick up the unit of lumber is also part of the method. Closing valves on the hydraulic cylinder when the lumber grabber lowered to a commanded height to pick up the unit of lumber. The method also includes commencing raising by the hoist of the crane the lumber grabber the unit of lumber when the forks are closed.

Each of the features discussed in this particular implementation section for the first system implementation apply equally to this method implementation. As indicated above, all the system features are not repeated here and should be considered repeated by reference.

In one implementation, our method further includes measuring with load cells a weight of the unit of lumber while the lumber grabber is holding the unit of lumber.

In one implementation, our method further includes moving the unit of lumber with the crane to a next drop position under guidance from a 3D vision system, a proximity to surface sensor such as a laser ranging device/sensor, vision system, or other types of sensors, e.g., tactile, sonic, etc., or the like or a combination of thereof.

In one implementation, our method further includes lowering the hoist. When the hoist has lowered to an approximate height, e.g., as detected by a proximity to surface sensor such as a laser ranging device/sensor, vision system, or other types of sensors, e.g., tactile, sonic, etc., or the like or a combination of thereof, slowing a lowering rate of the hoist until load cells (sensors of the crane) detect that loading on the cable suspending the lumber grabber has fallen to/below a threshold, indicating that the unit of lumber has been fully placed. Actuating latch actuators allowing the forks to open; commence raising the hoist when the forks have fully opened; and open the hydraulic valve allowing the plate to lower are also part of this implementation of our method.

In one implementation, our method further includes tracking, using an Inventory Management system, locations of units of lumber in a warehouse in which the lumber grabber is situated.

In one implementation, our method further includes tracking, using an Inventory Management system, dimensions of units of lumber in a warehouse in which the lumber grabber is situated.

Other implementations may include a non-transitory computer readable storage medium storing instructions executable by a processor to perform a method as described above. Yet another implementation may include a system including memory and one or more processors operable to execute instructions, stored in the memory, to perform a method as described above.

We claim as follows:

1. A lumber grabber workstation for grasping packages of lumber, the lumber grabber comprising:
a frame;
a set of movable carriages movably supported by the frame;
two sets of forks, each set of forks positioned on one of the movable carriages at either end of the frame and arranged diametrically opposed to each other;
a motor; and
a set of one or more rotatable ball screw shafts connected to and driven by the motor and to the movable carriages, to change relative positions of the movable carriages at either end of the frame; thereby enabling grasping and ungrasping of packages of lumber under programmed control of a programmable controller executing stored instructions.

2. The lumber grabber workstation according to claim 1, further including:
a self-leveling device comprised of a plate positioned so that when the plate rests on a unit of lumber a slight slack rope condition is created in a crane to which the lumber grabber frame is attached, to force the forks of the grabber to level themselves to the unit of lumber.

3. The lumber grabber workstation according to claim 2, further including a hydraulic cylinder attached to the plate, thereby enabling height of the plate to be set by allowing hydraulic fluid to flow out of a cylinder as it is compressed until a hoist of the crane reaches a commanded position.

4. The lumber grabber workstation according to claim 3, wherein the commanded position is given by a PLC controller and Inventory Management system that tracks locations and dimensions of units of lumber in a warehouse.

5. The lumber grabber workstation according to claim 4, further including a vision system that measures an exact height of the unit of lumber for verification.

6. The lumber grabber workstation according to claim 1, further including one or more thru-beam photo sensors mounted near a rear base of the forks to tell the programmable controller that the frame is in a clear position to close the forks to pick up a unit of lumber.

7. The lumber grabber workstation according to claim 1, wherein the lumber grabber has a payload range includes a payload of up to 35,000 pounds (lbs).

8. The lumber grabber workstation according to claim 1, wherein a width of lumber packages movable by the lumber grabber workstation is in a range between 72 inches to 96 inches.

9. The lumber grabber workstation according to claim 1, wherein each set of forks has a travel distance in a range between 0 and 54 inches.

10. The lumber grabber workstation according to claim 1, wherein the sets of forks have an opening width in a range between 0 and 108 inches.

11. The lumber grabber workstation according to claim 1, further including mechanical latches that engage into slots automatically locking forks into place so that the forks cannot open during crane travel.

12. The lumber grabber workstation according to claim 1, further including a set of absolute encoders, each connected to each ball screw to provide position feedback.

13. The lumber grabber workstation according to claim 12, further includes an extreme open and closed proximity switch for double verification of fork position.

14. A method of grasping packages of lumber, the method comprising:
lowering using a hoist of a crane a lumber grabber down to pick up a unit of lumber, wherein a movable plate attached to the lumber grabber via a hydraulic cylinder is in a fully down position due to gravity;
as the hoist lowers, the plate will make contact with a top of the lumber unit, substantially contemporaneously with the hoist of the crane continuing to lower thereby creating a slack rope condition in the hoist;
opening valving on the hydraulic cylinder allowing the lumber grabber to lower;
detecting using thru-beam photo sensors mounted near a rear base of forks on either side of the lumber grabber that the lumber grabber is in a clear position to close the forks to pick up the unit of lumber;
closing valves on the hydraulic cylinder when the lumber grabber is lowered to a commanded height to pick up the unit of lumber; and
commencing raising by the hoist of the crane the lumber grabber the unit of lumber when the forks are closed.

15. The method according to claim 14, further including measuring with load cells a weight of the unit of lumber while the lumber grabber is holding the unit of lumber.

16. The method according to claim 14, further including moving the unit of lumber with the crane to a next drop position under guidance from a 3D vision system, or a proximity to surface sensor including a laser ranging device/sensor.

17. The method according to claim 14, further comprising:
lowering the hoist;
detecting by a proximity to surface sensor when the hoist has lowered to an approximate height, and thereupon slowing a lowering rate of the hoist until detecting that loading on the cable suspending the lumber grabber has fallen to a threshold, thereby indicating that the unit of lumber has been fully placed;
actuating one or more latch actuators allowing the forks to open;
commence raising the hoist when the forks have fully opened; and
open the hydraulic valve allowing the plate to lower.

18. The method according to claim 14, further including tracking using an Inventory Management system, locations of units of lumber in a warehouse in which the lumber grabber is situated.

19. The method according to claim 14, further including tracking using an Inventory Management system, dimensions of units of lumber in a warehouse in which the lumber grabber is situated.

20. A non-transitory computer readable medium storing instructions that, when executed by one or more processors, implement a method of:
lowering using a hoist of a crane a lumber grabber down to pick up a unit of lumber, wherein a movable plate attached to the lumber grabber via a hydraulic cylinder is in a fully down position due to gravity;
as the hoist lowers, the plate will make contact with a top of the lumber unit, contemporaneously with the hoist of the crane continuing to lower thereby creating a slack rope condition in the hoist;
opening valving on the hydraulic cylinder allowing the lumber grabber to lower;
detecting using thru-beam photo sensors mounted near a rear base of forks on either side of the lumber grabber that the lumber grabber is in a clear position to close the forks to pick up the unit of lumber;
closing valves on the hydraulic cylinder when the lumber grabber is lowered to a commanded height to pick up the unit of lumber; and
commencing raising by the hoist of the crane the lumber grabber the unit of lumber when the forks are closed.

21. A lumber grabber for grasping timber, including:
a frame, affixable to a crane;
a source of motive force;
moveable forks for grasping lumber movably supported by the frame, affixable to a crane; and
wherein the forks are positioned at ends of the frame and arranged to open and close relative to one other under power by the source of motive force; thereby enabling grasping and ungrasping of packages of lumber under programmed control of a programmable controller executing stored instructions.
